(19) United States
(12) Patent Application Publication
(10) Pub. No.: US 2007/0253340 A1
(43) Pub. Date: Nov. 1, 2007

(54) Method and apparatus for selective presence notification

(75) Inventors: Douglas W. Varney, Naperville, IL (US); Raymond O. Colbert, Naperville, IL (US)

Correspondence Address: Richard J. Minnich, Esq.;Fay, Sharpe, Fagan, Minnich & McKee, LLP, Seventh Floor, 1100 Superior Avenue, Cleveland, OH, 44114-2579, US

(73) Assignee: Lucent Technologies Inc.

(21) Appl. No.: 11/413,834

(22) Filed: Apr. 28, 2006

(51) Int. Cl. H04J 1/16

(52) U.S. Cl. 370/252; 370/401

(57) ABSTRACT

A method and apparatus for reducing network resources from presence notification traffic. This invention assumes a standard presence architecture of presentities, watchers, and a presence server involved in pushing (notifying) watchers when a presentity's state changes. In addition, there exists a source of past communication data (or other data providing a means of prioritization) for a subscriber. The presence server determines, based upon the past communication data (or other prioritization data) of a subscriber, whether to notify about the presentity's state change immediately or to wait on notifying the watcher until either additional notify messages also need to be sent (and can be bundled in one message) or a guard timer expires. In this fashion, the presence information that the subscriber cares about is delivered in real time while the information that is less important to the subscriber consumes less network resources.

### BACKGROUND OF THE INVENTION

This invention relates to a method and apparatus for selective presence notification in order to reduce network resources from presence notification traffic.

While the invention is particularly directed to the art of telecommunications, and will be thus described with specific reference thereto, it will be appreciated that the invention may have usefulness in other fields and applications.

By way of background, wireless communication networks, which are well known, allow mobile devices to communicate with each other and other networks, such as the Internet and the public switched telephone network (PSTN). First and second generation wireless telephone systems are generally constrained in the amount of bandwidth available for communication, which limits capacity and also the types of services that can be provided. Third generation (3G) wireless systems, which are being developed through the 3rd Generation Partnership Project (3GPP), promise greater bandwidth, thereby increasing capacity and allowing for enhanced services. Common examples of such applications are Push-to-Talk and Instant Messaging.

3G networks may utilize IP multimedia subsystems (IMS). The IMS relates to a technology standardized by 3GPP and used to join mobile communication with IP technologies by adding the ability to deliver integrated voice and data services over the IP-based packet switched network. IMS services are based on the Session Initiation Protocol (SIP), which is the signaling protocol standard for next-generation 3GPP mobile wireless networks.

Presence and availability or simply “presence” is a key enabler for next generation services such as Push-to-Talk and Instant Messaging, facilitating communications among “communities of interest” such as groups of friends, colleagues working in the same projects, or families.

Presence, also known as presence information, is regarded as the willingness and availability to communicate across a set of devices. Presence can be provided to users as a service where a user (watcher) subscribes to presence information regarding other users (presentities). The watcher can subscribe to various presentities and organize them on a buddy list. Using the buddy list, the watcher receives the status of the presentities, which could include availability as on-line, off-line and do not disturb. Other presence information that can be included is the presentities geographical location and the person's mood and preferred communication means.

Traffic generated by presence servers depends mostly on the number of states the user can enter and the sizes of the users' buddy lists. The types of states, e.g., on-line, on phone, etc. have also some impact on the traffic since some states are more likely to be used than others. Although the sizes of the messages being generated by presence servers seem to be small, the high frequency of such messages has a great impact on wireless networks. SIP/SIMPLE for presence typically results in large numbers of small payload messages, which may be fine for systems with low setup costs. However, presence servers and wireless network such as UMTS or CDMA EvDO were not designed for carrying small payload messages due to the high setup costs.

Using pull strategy and throttling may limit the frequency of these messages. Limiting the frequency of the messages sent is important since sending small bursts of traffic consumes in overhead in terms of setting up and tearing down the radio bearers. This overhead is often quite large in comparison to the presence message that is to be sent and efficiencies gained by combining several messages together.

Several optimization techniques have been developed. For example in publication/update throttling, the presentity controls the rate of updates the rate of updates that get sent to the presence server. The presentity does not make any automatic presence updates (e.g., updates when the presentity is in active). The presentity does not allow a client to send an update within a minimum interval, i.e., the presentity does not send a publication to the present server if the updates occur within a minute (configurable parameter).

With pull for presence, instead of subscribing for the presence updates of the buddies list, the presentity does a periodic pulling for presence status of its buddies. A fetch request for presence information of its buddies as and when required at configurable intervals.

With notification throttling, the presence server limits the frequency of updates sent to the presentity. When a presentity updates the presence server, the presence server generates notifications to watchers only at fixed intervals of time. If multiple updates occur with that minimal interval, the notifications are not generated to the watchers.

A resource list server may reduce the number of subscriptions sent to the presence server, and that single notification can contain the status of multiple contacts. If a contact is across multiple buddy lists across multiple subscribes, the resource list server aggregates the subscription to the presence server, further reducing the subscription traffic to the presence server. This works in conjunction with notification throttling.

Yet there remains a need to reduce the amount of messages being generated by the presence servers. As such, the present invention contemplates a new and improved method and apparatus that resolves the above-referenced difficulties and others.

### SUMMARY OF THE INVENTION

A method and apparatus for reducing network resources from presence notification traffic are provided. This invention assumes a standard presence architecture of presentities, watchers, and a presence server involved in pushing (notifying) watchers when a presentity's state changes. In addition, there exists a source of past communication data (or other data providing a means of prioritization) for a subscriber. The presence server determines, based upon the past communication data, current activity, (or other prioritization data) of a subscriber, whether to notify about the presentity's state change immediately or to wait on notifying the watcher until either additional notify messages also need to be sent (and can be bundled in one message) or a guard timer expires. In this fashion, the presence information that the subscriber cares about at that moment is delivered in real time while the information that is less important to the subscriber consumes less network resources.

The prioritization data and rules can be flexible. For example, a pattern could be discerned where during working hours that the watcher communicates with a different set of presentities than during non-working hours and a decision on whether to send the notification could take than into account. Or, it may be that a watcher only communicates using voice and thus a presence state update on the presentities instant message status can take lower priority. Or, it may be that a watcher is currently using instant messaging and hence the instant message status is a high priority. Further, the setting of a guard timer can be dependent on the priority determination. A presentity may appear to be of middle priority and thus get a shorter guard timer interval than a presentity of lower priority. The guard timer concept can be expanded to encompass whether to send immediately (e.g., guard timer of 0) or never send as a NOTIFY on its own (e.g., guard timer of infinity) and all points in between.

In accordance with one aspect of the present invention a method of processing presence notification traffic for a watcher in a telecommunications network is provided. The method comprises: receiving a notification of presence state from a presentity; retrieving the watcher's priority data for the presentity from a priority database; retrieving rules for processing presence notification traffic from a rules database; determining the priority of the notification based on the priority data and the rules; and processing the notification based on its priority.

In accordance with another aspect of the present invention there is provided a system for processing presence notification traffic for a watcher in a telecommunications network is provided. The system comprises: means for receiving a notification of presence state from a presentity; means for retrieving the watcher's priority data for the presentity from a priority database; means for retrieving rules for processing presence notification traffic from a rules database; and means for determining the priority of the notification based on the priority data and rules.

In accordance with yet another aspect of the present invention there is provided a system for processing presence notification traffic for a watcher in a telecommunications network. The system comprises: a priority database for storing priority data for one or more presentities; a rules database for storing rules for processing presence notification traffic; and a presence server. The presence server is operative to: receive notifications of presence states from one or more presentities; retrieve the watcher's priority data for the presentity from the priority database; retrieve rules for processing presence notification traffic from a rules database; and determine the priority of each notification based on the priority data and rules.

Further scope of the applicability of the present invention will become apparent from the detailed description provided below. It should be understood, however, that the detailed description and specific examples, while indicating preferred embodiments of the invention, are given by way of illustration only, since various changes and modifications within the spirit and scope of the invention will become apparent to those skilled in the art.

### DESCRIPTION OF THE DRAWINGS

The present invention exists in the construction, arrangement, and combination of the various parts of the device, and steps of the method, whereby the objects contemplated are attained as hereinafter more fully set forth, specifically pointed out in the claims, and illustrated in the accompanying drawings in which:

FIG. 1 represents a view of a telecommunications system into which the exemplary embodiments may-be incorporated; and

FIG. 2 illustrates a flowchart of a selective presence notification method according to aspects of the present invention.

### DETAILED DESCRIPTION

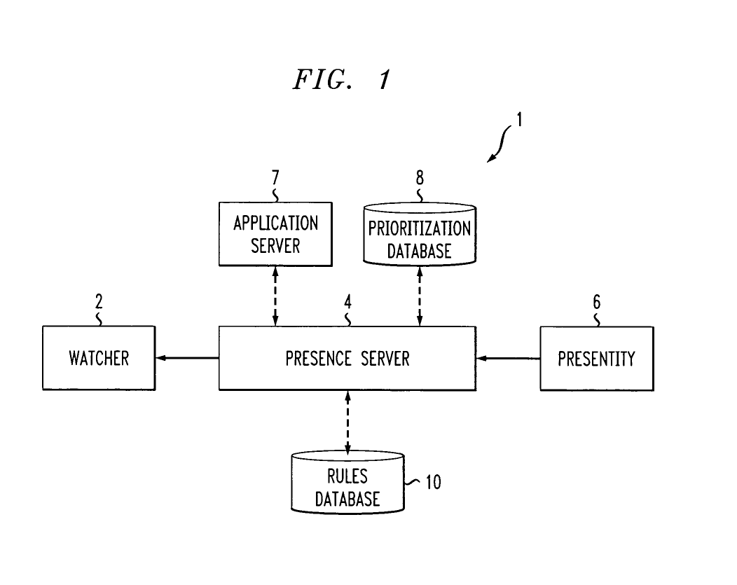

Referring now to the drawings wherein the showings are for purposes of illustrating the exemplary embodiments only and not for purposes of limiting the claimed subject matter, FIG. 1 provides a view of a telecommunications system 1 into which the presently described embodiments may be incorporated. As shown generally, FIG. 1 includes a watcher 2, a presence server 4, at least one presentity 6. Optionally, the system 1 may include one or more application servers 7 that can indicate presence activity of the watcher 2.

The watcher 2 receives notifications about one or more presentities 6 from the presence server 4. In order to reduce presence notification traffic, the presence server 4 includes at least two databases: (a) a prioritization database 8, which includes data accumulated from various types of communications such as call logs, billing records, and the like, and (b) a rules database 10, which includes the rules to be applied to data in regard to each of the presentities 6. The content of these databases will be explained in greater detail later. Further, the application server 7 may be linked to the presence server 4. The application server 7 typically executes a particular service for the watcher 2, including Instant Messaging, Chat, Push-to-Talk and the like.

It is well known that presence can consist of different types of information that can be grouped into categories such as (a) usage information, (b) availability information, (c) mood information, (d) geographical information, and (e) reachability.

Usage information is the most basic feature the presence server 4 can offer and consists of information on whether the presentity is registered to the service or not. The natural states of the presentity are on-line and off-line.

The next level of presence is to include availability information, i.e., the possibility to react the presentity with an instant message, phone call, etc. The presentity status could be busy, away, or do not disturb (dnd). In a more advanced application, more specific states may exist. Examples of such specific states could be “out to lunch” or “in meeting.”

Presentities can publish their current mood to their friends. By publishing the mood, further messages between the presentity watchers are encouraged.

The presentities 6 could, in the simplest case, manually edit their whereabouts (i.e., geographical information), which would then be sent to the watcher. Such information could, for example, be set to “at work” or “at home.” In a more advanced case, the location of the presentity could be set automatically by the equipment using some kind of positioning system.

Presence information could also include the presentities supported and preferable communication means, i.e., reachability. The presentity could set priority on which kind of communication it prefers to be contacted by. For example, Instant Messaging could have the highest priority, i.e., a priority of 1, email could have a priority of 5, phone calls could have a priority of 10, and SMS could have a priority of 20.

There are several types of protocols for presence services as known to those skilled in the art, including IMPP (instant messaging in presence protocol), XMPP (extensible messaging and presence protocol) and SIMPLE (SIP for instant messaging and presence leveraging extensions).

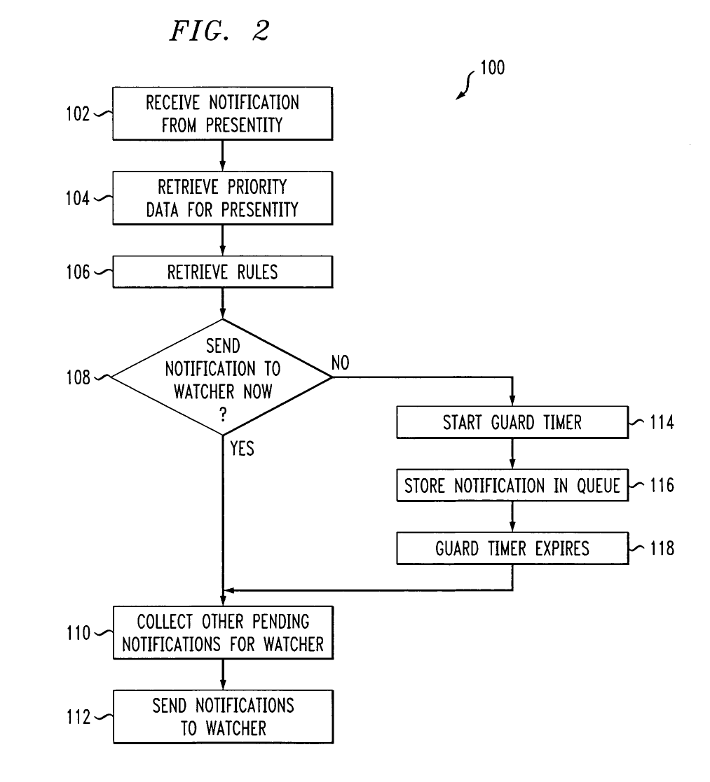

In accordance with aspects of the present invention, a method 100 of reducing presence generated traffic is shown in FIG. 2. The method 100 is based upon the principle that the network operator will transmit immediately presence information to the watcher 2 only for those presentities that the watcher 2 communicates with frequently or is associated with an activity the watcher 2 is involved in.

The determination as to whether a notification from a given presentity 6 is “high priority” can be based, for example, on a Pareto analysis. The Pareto distribution, named after the Italian economist Vilfredo Pareto, is a power law probability distribution found in a large number of real-world situations. Outside the field of economics it is at times referred to as the Bradford distribution.

Pareto originally used this distribution to describe the allocation of wealth among individuals since it seemed to show rather well the way that a larger portion of the wealth of any society is owned by a smaller percentage of the people in that society. This idea is sometimes expressed more simply as the Pareto principle or the “80-20 rule” which says that 20% of the population owns 80% of the wealth. This distribution is not limited to describing wealth or income distribution, but to many situations in which an equilibrium is found in the distribution of the “small” to the “large.” Thus, in our case, it may be assumed that 80% of the communications are to 20% of the people on the watcher's buddy list.

Of course, prioritization of presence information messages may be based other than on a Pareto distribution. For example, the presence server 4 may immediately transmit presence information associated with current activity of the watcher 2 (that is reflected in the watcher's presence information). Also, explicit subscriber preferences can be incorporated. Further, as noted earlier, the application server 7 executes a particular service for the watcher 2, including Instant Messaging, Chat, Push-to-Talk and the like and can indicate presence activity of the watcher 2. Thus, the application status of the watcher 2 may be used to prioritize presence information messages. For example, if the watcher 2 is utilizing Instant Messaging, presence information relating to this application may be given a higher priority.

Thus, turning now to FIG. 2, we see that, initially, an incoming notification from the presentity 6 is received by the presence server 4 (102). As a result, the presence server 4 retrieves priority data about the presentity 6 from the point of view of the watcher 2 as found in the prioritization database 8 (104). In this respect, the prioritization database 8 includes all types of usage data, including call logs, billing records, and usage counts. The prioritization database 8 may include the summary of the above data types. In other words, a data mining type procedure may be employed to determine the communications/community patterns. Of course, it is to be understood that real-time data could be used as well. For example: if a presentity calls the watcher 2 then even though that presentity is not one of the 20% on the high priority list, at least for a while, immediate presence information on that presentity should be passed to the watcher 2. Optionally, the presence server 4 may retrieve from the application server 7 the current application status of the watcher 2.

Next, the presence server 6 retrieves all rules applying to the current context from the rules database 10 (106). Some examples of such rules that may be found in the rules database 10 are: “if watcher has communicated with presentity in the last week then notify immediately,” “if watcher has not communicated with presentity in the last month, set guard timer for twenty minutes,” “if presentity is high priority notify watcher immediately,” “if watcher is using instant messaging and the presence update of a presentity is about the instant messaging service then notify watcher immediately”, etc. In other words, the rules are used to help determine the priority for a notification from a given presentity at a given time. For example, based on the rules, high priority notifications may be sent immediately, medium priority notifications may be sent at a given interval through the use of a guard timer, and low priority notifications may be tacked on to higher priority messages.

It is to be understood that the prioritization data and rules associated with the watcher 2 can be flexible. For example, a pattern could be discerned where during working hours the watcher 2 communicates with a different set of presentities than during non-working hours, and a decision on whether to send the notification could such information into account. Or, it may be that the watcher 2 only communicates using voice and thus a presence state update on the presentity's instant message status can take lower priority.

Thus, in the next step, a determination is made as to whether the notification from the presentity 6 should be sent immediately based upon the applicable rules (108). If that is indeed the case, then any other pending notifications and/or messages for the watcher 2 are to be collected (110) and all of the notifications and/or messages are sent to the watcher 2 (112). Otherwise, a guard timer is started (114). The setting of the guard timer can be dependent on the priority determination. For example, one presentity may appear to be of middle priority and thus get a shorter guard timer interval than a presentity of lower priority. The guard timer concept can be expanded to encompass whether to send immediately (guard timer of 0) or never send as a NOTIFY on its own (guard timer of infinity) and all points in between.

Meanwhile, the notification is stored in a queue on the presence server 4 (116) until the guard timer expires (118). Once the guard timer expires, any other pending notifications (i.e., low priority notifications) and/or messages for the watcher 2 are to be collected (110) and all of the notifications and/or messages are sent to the watcher 2 (112).

The detailed description above is represented largely in terms of processes and symbolic representations of operations performed by conventional computer components, including a central processing unit (CPU), memory storage devices for the CPU, and connected display devices. These operations include the manipulation of data bits by the CPU, and the maintenance of these bits within data structures that reside in one or more of the memory storage devices. Such data structures impose a physical organization upon the collection of data bits stored within computer memory and represent specific electrical or magnetic elements. These symbolic representations are the means used by those skilled in the art of computer programming and computer construction to most effectively convey teachings and discoveries to others skilled in the art.

For the purposes of this discussion, a process is generally conceived to be a sequence of computer-executed steps leading to a desired result. These steps generally require physical manipulations of physical quantities. Usually, though not necessarily, these quantities take the form of electrical, magnetic, or optical signals capable of being stored, transferred, combined, compared, or otherwise manipulated. It is conventional for those skilled in the art to refer to these signals as bits, values, elements, symbols, characters, terms, objects, numbers, records, files or the like. It should be kept in mind, however, that these and similar terms should be associated with appropriate physical quantities for computer operations, and that these terms are merely conventional labels applied to physical quantities that exist within and during operation of the computer.

In addition, it should be understood that the programs, processes, methods, etc. described herein are not related or limited to any particular computer or apparatus. Rather, various types of general purpose machines may be used with programs constructed. in accordance with the teachings described herein. Similarly, it may prove advantageous to construct specialized apparatus to perform the method steps described herein by way of dedicated computer systems with hard-wired logic or programs stored in nonvolatile memory, such as read only memory.

The above description merely provides a disclosure of particular embodiments of the invention and is not intended for the purposes of limiting the same thereto. As such, the invention is not limited to only the above-described embodiments. Rather, it is recognized that one skilled in the art could conceive alternative embodiments that fall within the scope of the invention.

We claim:

1. A method of processing presence notification traffic for a watcher in a telecommunications network, the method comprising:
receiving a notification of presence state from a presentity;
retrieving the watcher's priority data for the presentity from a priority database;
retrieving rules for processing presence notification traffic from a rules database;
determining the priority of the notification based on the priority data and the rules; and
processing the notification based on its priority.

2. The method defined in claim 1, further comprising:
receiving the current application status of the watcher.

3. The method defined in claim 1, further comprising:
sending the notification to the watcher immediately along with any other pending notifications when the notification is determined to be of high priority.

4. The method defined in claim 3 wherein the determination as to whether a notification from the presentity is of high priority is based on a Pareto analysis.

5. The method defined in claim 4, further comprising:
starting a guard timer when the notification is determined to be of medium priority; and
storing the notification in a queue until the guard timer expires.

6. The method defined in claim 3, further comprising:
starting a guard timer when the notification is determined to be of medium priority; and
storing the notification in a queue until the guard timer expires.

7. A system for processing presence notification traffic for a watcher in a telecommunications network, the system comprising:
means for receiving a notification of presence state from a presentity;
means for retrieving the watcher's priority data for the presentity from a priority database;
means for retrieving rules for processing presence notification traffic from a rules database; and
means for determining the priority of the notification based on the priority data and rules.

8. The system defined in claim 7, further comprising:
means for receiving the current application status of the watcher.

9. The system defined in claim 7, further comprising:
means for sending the notification to the watcher immediately along with any other pending notifications when the notification is determined to be of high priority.

10. The system defined in claim 9 wherein the determination as to whether a notification from the presentity is of high priority is based on a Pareto analysis.

11. The system defined in claim 10, further comprising:
means for starting a guard timer when the notification is determined to be of medium priority; and
means for storing the notification in a queue until the guard timer expires.

12. The method defined in claim 9, further comprising:
means for starting a guard timer when the notification is determined to be of medium priority; and
means for storing the notification in a queue until the guard timer expires.

13. A system for processing presence notification traffic for a watcher in a telecommunications network, the system comprising:
a priority database for storing priority data for one or more presentities;
a rules database for storing rules for processing presence notification traffic; and
a presence server operative to:
receive notifications of presence states from one or more presentities;
retrieve the watcher's priority data for the presentity from the priority database;
retrieve rules for processing presence notification traffic from a rules database; and
determine the priority of each notification based on the priority data and rules.

14. The system defined in claim 13, wherein the presence server is further operative to receive the current application status of the watcher.

15. The system defined in claim 13, wherein the presence server is further operative to:
send the notification to the watcher immediately along with any other pending notifications when the notification is determined to be of high priority.

16. The system defined in claim 15 wherein the determination as to whether a notification from the presentity is of high priority is based on a Pareto analysis.

17. The system defined in claim 16, wherein the presence server is further operative to:
start a guard timer when the notification is determined to be of medium priority; and
store the notification in a queue until the guard timer expires.

18. The system defined in claim 15, wherein the presence server is further operative to:
start a guard timer when the notification is determined to be of medium priority; and
store the notification in a queue until the guard timer expires.
